(19) United States
(12) Patent Application Publication
(10) Pub. No.: US 2010/0044367 A1
(43) Pub. Date: Feb. 25, 2010

(54) INDUCTION HEATING DEVICE

(75) Inventors: Won Tae KIM, Seoul (KR); Seung Hee Ryu, Seoul (KR); Byeong Wook Park, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/195,987

(22) Filed: Aug. 21, 2008

(51) Int. Cl. H05B 6/04

(52) U.S. Cl. 219/660

(57) ABSTRACT

An induction heating device includes a main body, an induction coil provided in the main body and forming an electromagnetic field, and an induction coil driving circuit unit positioned in the main body to be physically and thermally separated from the induction coil.

### BACKGROUND OF THE INVENTION

1. Field of the Invention

The present invention relates to an induction heating device and, more particularly, to an induction heating device including a circuit unit separated from an induction coil.

2. Description of the Related Art

An induction heating device, which induces metal such as a cooking container or the like to be electrified by means of electromagnetic force so as to generate heat, is commonly employed for cooking devices such as an induction range, a rice-cooker, an electric kettle, and the like.

Because the induction heating device uses the electromagnetic force, heat is generated in the interior of the induction heating device and, in this case, if the induction heating device is overheated, internal components such as an electric element, sensitive to temperature may be easily damaged. In particular, if the induction heating device is used in a cooking device, it would be required to output high induction heat for the promptness of cooking, and the induction heating devices increasingly tend to have a compact structure, particularly with built-in devices. Thus, the induction heating device is required to have a desirable heat releasing (heat sinking or heat dissipation) function so as to cause a problem such as overheating of an electric element or the like which is sensitive to temperature while satisfying the requirements of a small and compact structure with a sufficient output performance.

### SUMMARY OF THE INVENTION

Thus, an object of the present invention is to provide an induction heating device capable of having a small and compact structure, and which prevents an electric element, or the like, sensitive to temperature, from being overheated.

Another object of the present invention is to provide an induction heating device capable of preventing transfer of heat of an induction coil to a circuit unit including an electric element, or the like, sensitive to temperature, to thus prevent the circuit unit from being overheated.

Still another object of the present invention is to provide an induction heating device capable of preventing a circuit unit from being overheated by forming an independent air-cooling flow path in the circuit unit.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view of an induction heating device according to an exemplary embodiment of the present invention.

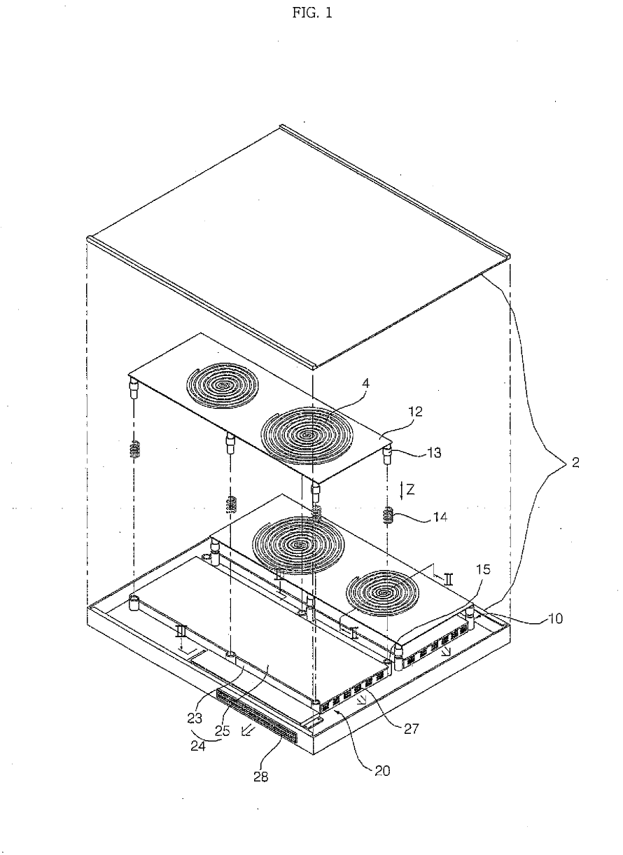

FIG. 2 is a cross-sectional view taken along line II-II in FIG. 1.

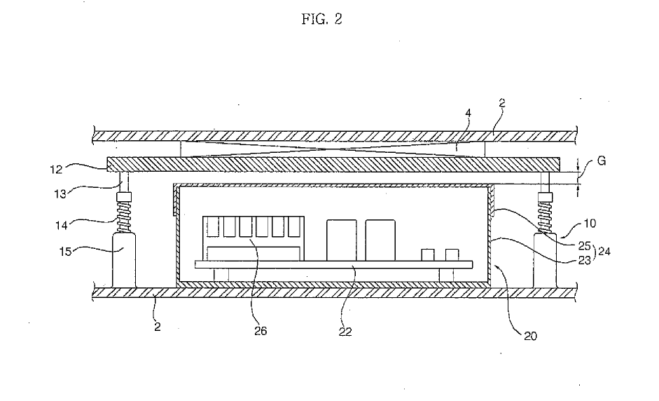

FIG. 3 is a cross-sectional view taken along line III-III in FIG. 1.

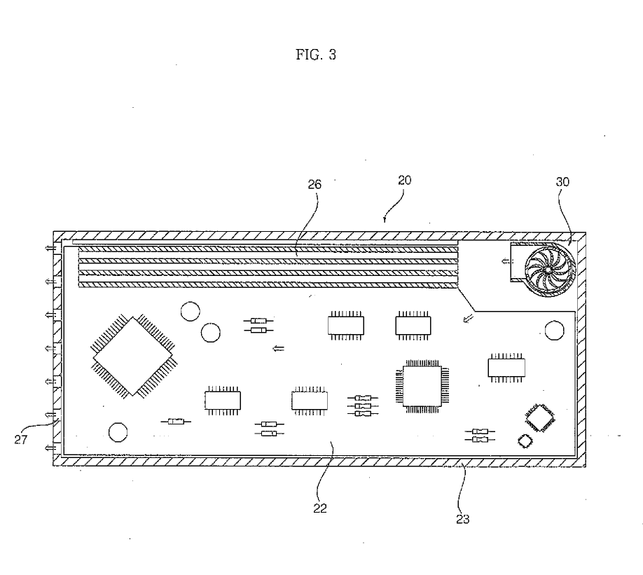

### DETAILED DESCRIPTION OF THE PREFERRED EMBODIMENT

The foregoing and other objects, features, aspects and advantages of the present invention will become more apparent from the following detailed description of the present invention when taken in conjunction with the accompanying drawings. The present invention may be implemented in various forms without being limited to the embodiments described hereinafter.

An induction heating device according to an exemplary embodiment of the present invention will now be described with reference to the accompanying drawings.

The induction heating device according to an exemplary embodiment of the present invention includes a main body 2, an induction coil 4, and a circuit unit 20 driving the induction coil 4. The circuit unit 20 is positioned to be separated from the induction coil 4.

The induction heating device according to the exemplary embodiment of the present invention may further include an induction coil base 12 provided under the induction coil 4 to support the induction coil 4, and a support unit 10 that supports the induction coil base 12.

The support unit 10 of the induction heating device according to the exemplary embodiment of the present invention may include support shafts 13 provided at a lower portion of the induction coil base 12, and elastic members 14 provided at the support shafts 13 and allowing the induction coil base 12 to have elasticity in a vertical direction.

The circuit unit 20 of the induction heating device according to the exemplary embodiment of the present invention may include a circuit board 22 that supplies power to the induction coil 4, and a thermally insulating member comprising a box-shaped circuit body 24 that encloses the circuit board 22 and includes an air-cooling flow path formed therein.

The induction heating device according to the exemplary embodiment of the present invention may further include an air blower 30 provided at one side of the circuit body 24 and supplying air through the air-cooling flow path, and discharge holes 27 formed on the other side of the circuit body 24 and discharging air that has passed through the air-cooling flow path.

The circuit body 24 of the induction heating device according to the exemplary embodiment of the present invention may include a circuit case 23 that covers the circumference and a lower portion of the circuit board 22, and a circuit cover 25 that covers an upper portion of the circuit board 22.

A cooking container available for induction heating is mounted on an upper portion of the main body 2. An air entrance 28 is preferably formed at the main body 2 to allow air to be sucked from the outside of the main body 2 into the main body 2 or allow air to be discharged from the main body 2 to the outside of the main body 2, by means of the air blower 30. The air entrance 28 formed at the main body 2 may be provided in the form of a hole at a position immediately communicating with the outside of the main body 2, or a duct may be connected to the air entrance 28. In addition, preferably, the air entrance 28 may be formed at a position allowing air discharged through the discharge holes 27 formed at the circuit body 24, to be exhausted from the main body 2.

The induction coil 4 forms an electromagnetic field to heat a cooking container. In this case, the induction coil 4 forms the electromagnetic field upon receiving power from the circuit board 22 of the circuit unit 20. The induction coil 4 includes the induction coil base 12 that supports the induction coil 4.

The induction coil base 12 is provided under the induction coil 4 to support the induction coil 4. Preferably, the induction coil base 12 is made of an aluminum material that can perform a shielding function to prevent the electromagnetic field formed by the induction coil 4 from affecting the circuit board 22 of the circuit unit 20. The induction coil base 12 is positioned to be separated by a certain gap (G) from the circuit unit 20 so as not to allow heat generated when the cooking container is heated from being directly transmitted to the circuit unit 20.

The support unit 10 supports the induction coil base 12. The support unit 10 may be implemented in various ways such that the induction coil base 12 is separated from a bottom surface of the main body 2 and the induction coil 4 is tightly attached to an upper surface of the main body 2. According to the exemplary embodiment of the present invention, preferably, the support shafts 13 are provided at a lower side of the induction coil base 12 and the elastic members 14 are provided at the support shafts 13 and allow the induction coil base 12 to have an elastic force in a vertical direction. In addition, preferably, insertion holes 15 are provided on the bottom surface of the main body 2, into which the supports 13 and the elastic members 14 are inserted. Preferably, the support units 10 are disposed at the perimeter of the induction coil base 12, and preferably, the circuit unit 20 is positioned between the plurality of support units 10.

Preferably, the support shafts 13 are disposed at the perimeter of the induction coil base 12 such that the induction coil base 12 can be separated from the bottom surface of the main body 2 and tightly attached to the upper surface of the main body 2. The support shafts 13 include the elastic members 14 to allow the induction coil base 12 to have elasticity substantially in a vertical direction. The elastic member 14 may be implemented in various forms such as a coil spring, a mechanical spring, a plate spring, rubber, sponge, etc., having elasticity. The support shafts 13 may be inserted into the insertion holes 15 provided on the lower surface of the main body 2 to allow the induction coil base 12 and the main body 2 to be combined.

The circuit unit 20 is positioned to be separated from the induction coil 4 so that heat of the induction coil 4 may not be directly transferred to the circuit unit 20, and drives the induction coil 4. Preferably, the circuit unit 20 is positioned to be separated by the certain gap (G) from the induction coil base 12. The circuit unit 20 may be placed at various positions horizontally or vertically so long as it is separated from the induction coil 4, and in the exemplary embodiment of the present invention, the circuit unit 20 is preferably positioned below the induction coil base 12 and between the support units 10. The circuit unit is preferably structurally compact and small.

The circuit unit 20 may be implemented in various ways, and according to the exemplary embodiment of the present invention, the circuit unit 20 includes the circuit board 22 that supplies power to the induction coil 4, and the box-shaped circuit body 24 that encloses the circuit board 22 and includes an air-cooling flow path formed therein. In addition, preferably, the circuit body 24 includes the circuit case 23 that covers the perimeter and the lower portion of the circuit board 22, and the circuit cover 25 that covers the upper portion of the circuit board 22.

The circuit board 22 supplies power of a high-frequency current to the induction coil 4 to enable the induction coil 4 to form an electromagnetic field. Preferably, the circuit board 22 includes the circuit cover 25 made of an insulation material that covers the circuit board 22 to thus prevent heat of the induction coil 4 from being directly transferred thereto. The insulation material may include mica or similar materials. In addition, preferably, the circuit board 22 includes the box-shaped circuit body 24 that encloses the circuit board 22 at the periphery of the circuit board 22 and includes the air-cooling flow path formed therein so that cooling can be smoothly performed. Preferably, a heat sink 26 is provided at the circuit board 22 to release heat of the electric elements on the circuit board 22.

The circuit body 24 has the box shape to enclose the circuit board 22 and includes the air-cooling flow path formed therein. The air blower 30 may be provided at one side of the circuit body 24 in order to supply air through the air-cooling flow path, and the discharge holes 27 may be provided at the other side of the circuit body 24 to discharge air which has passed through the air-cooling flow path. In order to enable a blowing force of the air blower 30 to be concentrated to the circuit unit 20, preferably, an independent air-cooling flow path is provided to be connected with the air blower 30. The discharge holes 27 may have a structure with a plurality of holes having a shape of a horizontal or vertical slit, or the discharge holes 27 may be formed as a single large hole. In addition, a louver (not shown) may be provided at the discharge holes 27.

Preferably, the circuit body 24 includes the circuit case 23 that covers the perimeter and the lower portion of the circuit board 22 and the circuit cover 25 that covers the upper portion of the circuit board 22. The presence of the circuit cover 25 has such advantages that the circuit body 24 can be easily structured and the circuit board 22 can be easily attached or detached and easily inspected or repaired.

The circuit body 24 may be formed as a molded product or formed as a mica sheet. Preferably, the circuit body 24 may be made of an insulation material to prevent heat of the induction coil 4 from being directly transferred to the circuit body 24.

The operation of the induction heating device according to the exemplary embodiment of the present invention will now be described.

With the cooking container avail mounted on the upper surface of the main body 2, when the induction coil 4 is driven by the circuit unit 20, so that the high-frequency current flows across the induction coil 4, an electromagnetic field is formed and the cooking container is heated by the thusly formed electromagnetic field. Although heat is generated as the cooking container is heated, the generated heat cannot be directly transferred to the circuit unit 20 positioned separately from the induction coil 4.

In addition, when the air blower 30 provided at one side of the circuit body 24 of the circuit unit 20 supplies air, the air is forcibly blown into the box-shaped circuit body 24 to cool the circuit board 22. The air that has cooled the circuit board 22 is discharged through the discharge holes 27 formed at the other side of the circuit body 24. Preferably, the air discharged through the discharge holes 27 is exhausted through the air entrance 28 of the main body 2. Because the air-cooling flow path is formed through the box-shaped circuit body 24, the circuit board 22 can be effectively cooled.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

The induction heating device according to the present invention has many advantages.

First, because the circuit unit is structurally separated from the induction coil, the degree of freedom with respect to the mutual installation positions of the circuit unit and the induction coil is high to facilitate designing a compact and small structure can be easily designed. The circuit unit can be structured to have an independent air-cooling flow path, and the circuit unit can be easily prevented from being overheated since it is insulated from the induction coil.

Second, because the support units are disposed to surround the circuit unit, the circuit unit can be separately positioned below the induction coil, and accordingly, designing of the compact and small structure can be further facilitated.

Third, because the circuit unit has the box shape, it can have the independent air-cooling flow path, so the heat generation characteristics of the circuit unit can be improved.

Fourth, because the circuit body of the circuit unit is made of an insulation material, heat transfer can be limited.

What is claimed is:

1. An induction heating device comprising:
an induction coil for producing an electromagnetic field;
an induction coil base for supporting the induction coil;
a circuit unit for driving the induction coil, the circuit unit being separated from the induction coil base; and
a thermally insulating member located between the induction coil base and the circuit unit.

2. The device of claim 1, further comprising a support unit supporting the induction coil base.

3. The device of claim 2, wherein the support unit comprises:
a support shaft provided under the induction coil base; and
an elastic member provided at the support shaft and allowing the induction coil base to have elasticity in a vertical direction.

4. The device of claim 2, wherein a plurality of support units are disposed at the periphery of the induction coil base, and the circuit unit is positioned between the plurality of the support units.

5. The device of claim 1, wherein the circuit unit comprises:
a circuit board that supplies power to the induction coil.

6. The device of claim 5, wherein said thermally insulating member includes a circuit cover made of a thermally insulating material.

7. The device of claim 5, wherein said thermally insulating member includes: a box-shaped circuit body that encloses the circuit board.

8. The device of claim 7, wherein the circuit body comprises:
a circuit case that covers the perimeter and a lower portion of the circuit board; and
a circuit cover that covers an upper portion of the circuit board.

9. The device of claim 7, wherein said thermally insulating member is made of a thermally insulating material.

10. The device of claim 2, wherein the induction coil base is made of an aluminum material.

11. The device of claim 2, wherein the circuit unit is positioned separately at a lower side of the induction coil base.

12. An induction heating device comprising:
an induction coil for producing an electromagnetic field;
a circuit unit that supplies power to the induction coil; and
a circuit unit housing for receiving the circuit unit and separating the circuit unit from the induction coil.

13. The device of claim 12, further comprising:
an air blower provided at one side of the circuit unit housing and configured to supply air through an air-cooling flow path; and
a discharge hole formed at the other side of the circuit unit housing and configured to discharge air that has passed through the air-cooling flow path.

14. The device of claim 13, wherein the discharge hole comprises at least one of a plurality of slit type holes, a single large hole, and a louver.

15. The device of claim 12, wherein the circuit unit housing is positioned to be thermally separated from the induction coil.

16. The device of claim 12, further comprising:
an induction coil base provided under the induction coil and supporting the induction coil; and
a support unit supporting the induction coil base.

17. The device of claim 16, wherein the support unit comprises:
a support shaft provided under the induction coil base; and
an elastic member provided at the support shaft and allowing the induction coil base to have elasticity in a vertical direction.

18. The device of claim 12, wherein the circuit unit housing comprises:
a circuit case that covers the perimeter and a lower portion of the circuit board; and
a circuit cover that covers an upper portion of the circuit board.

19. The device of claim 12, wherein the circuit unit housing is made of a thermal insulation material.

20. An induction heating device comprising:
an induction coil for producing an electromagnetic field;
an induction coil base for supporting the induction coil;
a circuit unit for driving the induction coil, the circuit unit being separated from the induction coil base; and
a circuit unit housing for receiving the circuit unit, the circuit unit housing including a thermally insulating member located between the induction coil base and the circuit unit for thermally separating the circuit unit from the induction coil.
